(19) United States
(12) Patent Application Publication
(10) Pub. No.: US 2013/0260097 A1
(43) Pub. Date: Oct. 3, 2013

(54) RESIN SLIDING MEMBER

(71) Applicant: DAIDO METAL COMPANY LTD., Nagoya (JP)

(72) Inventors: Yohei TAKADA, Inuyama (JP); Yoshifumi ITO, Inuyama (JP)

(73) Assignee: DAIDO METAL COMPANY LTD., Nagoya (JP)

(21) Appl. No.: 13/795,557

(22) Filed: Mar. 12, 2013

(30) Foreign Application Priority Data
Mar. 29, 2012 (JP) 2012-076601

(51) Int. Cl. B32B 5/16

(52) U.S. Cl. CPC B32B 5/16
USPC 428/143

(57) ABSTRACT

Disclosed is a resin sliding member, including: 0.5 to 25 vol % of calcium fluoride dispersed as particles; and a polyether ether ketone resin as a remainder. The calcium fluoride is crystalline, and a peak intensity of a (111) plane of the calcium fluoride exposed on a sliding surface is larger than a peak intensity of a (220) plane.

### INCORPORATION BY REFERENCE

The present application claims priority from JP Patent Application Ser. No. 2012-76601 filed on Mar. 29, 2012, the content of which is hereby incorporated by reference into this application.

### BACKGROUND OF THE INVENTION

(1) Field of the Invention

The present invention relates to a resin sliding member which does not contain lead or lead compounds and excels in friction and wear properties, and more particularly, to a resin sliding member suitable for a bearing of various vehicles such as an automobile, a bearing of general industrial machinery, or the like.

(2) Description of Related Art

Conventionally, a PEEK (polyether ether ketone) resin excels in heat resistance or sliding properties among synthetic resins, and in particular, is used for a sliding member of a part required to have a load bearing capacity or heat resistance under boundary lubrication or fluid lubrication. Moreover, it is known that wear resistance is increased by adding calcium fluoride to the PEEK resin.

### BRIEF SUMMARY OF THE INVENTION

As described in JP-A-61-118452, a resin sliding member in which a metal fluoride, in particular calcium fluoride is contained in a synthetic resin has the advantage of capable of increasing wear resistance of the resin sliding member by suppressing a strength reduction of a synthetic resin matrix. However, since the synthetic resin becomes worn after initial wear and the rigid calcium fluoride comes in direct contact with an opposed shaft, a friction coefficient is increased. In addition, the PEEK resin has a glass-transition temperature of 143° C., and thus there was a problem in that if the temperature of the resin sliding member including the PEEK resin as a matrix is increased to a temperature exceeding the glass-transition temperature of the PEEK resin in sliding, the resin sliding member cannot obtain excellent sliding properties. The present invention has been made in view of the circumstances, and it is an object of the present invention to provide a resin sliding member capable of suppressing a friction coefficient increase during steady wear while maintaining excellent wear resistance.

In order to achieve the above-described object, according to a first embodiment of the invention, in a resin sliding member comprising 0.5 to 25 vol % of calcium fluoride dispersed as particles and a polyether ether ketone resin as a remainder, the calcium fluoride is crystalline, and a peak intensity of a (111) plane of the calcium fluoride exposed on a sliding surface is larger than a peak intensity of a (220) plane.

According to a second embodiment of the invention, the resin sliding member further comprises 0.5 to 20 vol % of a solid lubricant.

According to a third embodiment of the invention, the solid lubricant is one or more selected from a fluorine resin, graphite and molybdenum disulfide.

According to a fourth embodiment of the invention, the resin sliding member further comprises 0.5 to 20 vol % of an inorganic filler.

According to a fifth embodiment of the invention, the inorganic filler is one or more selected from barium sulfate, a phosphate compound, potassium titanate, alumina, iron oxide and carbon fiber.

According to a sixth embodiment of the invention, an average particle diameter of the calcium fluoride is 1 to 20 μm.

In the first embodiment of the invention, in a resin sliding member comprising 0.5 to 25 vol % of calcium fluoride dispersed as particles and a PEEK resin as a remainder, the calcium fluoride is crystalline, and a peak intensity of a (111) plane of the calcium fluoride exposed on a sliding surface is made larger than a peak intensity of a (220) plane. The (111) plane of the calcium fluoride which is crystalline is a cleavage plane, and by making many (111) cleavage planes exist on particle surfaces of the calcium fluoride exposed on the sliding surface, a friction coefficient increase during steady wear can be suppressed.

Natural calcium fluoride has crystal orientation in which the peak intensity of the (220) plane is larger than the peak intensity of the (111) plane. In the case where a resin sliding member in which the calcium fluoride having such crystal orientation is dispersed in a PEEK resin is used, the calcium fluoride and the PEEK resin on a sliding surface of the resin sliding member slide in contact with an opposed shaft during initial wear, and the PEEK resin on the sliding surface preferentially becomes worn and the calcium fluoride projects on the sliding surface during steady wear. And then, when the calcium fluoride projecting on the sliding surface of the resin sliding member mainly slides in contact with the opposed shaft, a friction coefficient during steady wear is likely to be increased.

However, in the resin sliding member of the present invention, by dispersing, into the PEEK resin, particles of the calcium fluoride in which crystals are oriented such that many (111) cleavage planes exist on surfaces thereof, the calcium fluoride causes micro-shear (cleavage) on the cleavage planes inside of crystals near the particle surfaces when the calcium fluoride is in contact with the opposed shaft, and the calcium fluoride can be prevented from projecting on the sliding surface. Therefore, a friction coefficient increase of the resin sliding member during steady wear can be suppressed.

The filler content of the calcium fluoride is set to be 0.5 to 25 vol %. When the filler content of the calcium fluoride is less than 0.5 vol %, it is difficult to sufficiently exert an effect in wear resistance. In contrast, when the filler content of the calcium fluoride is more than 25 vol %, the friction coefficient during steady wear is increased even if the peak intensity of the (111) plane of the calcium fluoride is made larger than the peak intensity of the (220) plane.

According to the second embodiment of the invention, the resin sliding member of the present invention further comprises 0.5 to 20 vol % of a solid lubricant, so that sliding properties of the resin sliding member can be increased. According to the third embodiment of the invention, the solid lubricant is preferably one or more selected from a fluorine resin, graphite and molybdenum disulfide. However, another solid lubricant may be used.

According to the fourth embodiment of the invention, the resin sliding member of the present invention further comprises 0.5 to 20 vol % of an inorganic filler, so that sliding properties of the resin sliding member can be increased. According to the fifth embodiment of the invention, the inorganic filler is preferably one or more selected from barium sulfate, a phosphate compound, potassium titanate, alumina, iron oxide and carbon fiber. However, another inorganic compound may be used.

According to the sixth embodiment of the invention, an average particle diameter of the calcium fluoride is preferably 1 to 20 μm. As the average particle diameter of the calcium fluoride becomes smaller, a surface area per unit volume becomes larger and the calcium fluoride is tightly bonded to the PEEK resin matrix, and thus, separation of the calcium fluoride from the PEEK resin matrix is reduced. Therefore, the average particle diameter of the calcium fluoride is preferably 20 μm or less.

### BRIEF DESCRIPTION OF THE SEVERAL VIEWS OF THE DRAWING

FIG. 1 is a schematic diagram showing a resin sliding member in which calcium fluoride is dispersed in a PEEK resin;

FIG. 2 is a diagram showing a measurement result of an XRD method of calcium fluoride according to the present embodiment;

FIG. 3 is a diagram showing a measurement result of the XRD method of calcium fluoride according to the present embodiment;

FIG. 4 is a diagram showing results of a sliding test using a resin sliding member according to the present embodiment; and

FIG. 5 is a diagram showing results of the sliding test using the resin sliding member according to the present embodiment.

### DETAILED DESCRIPTION OF THE INVENTION

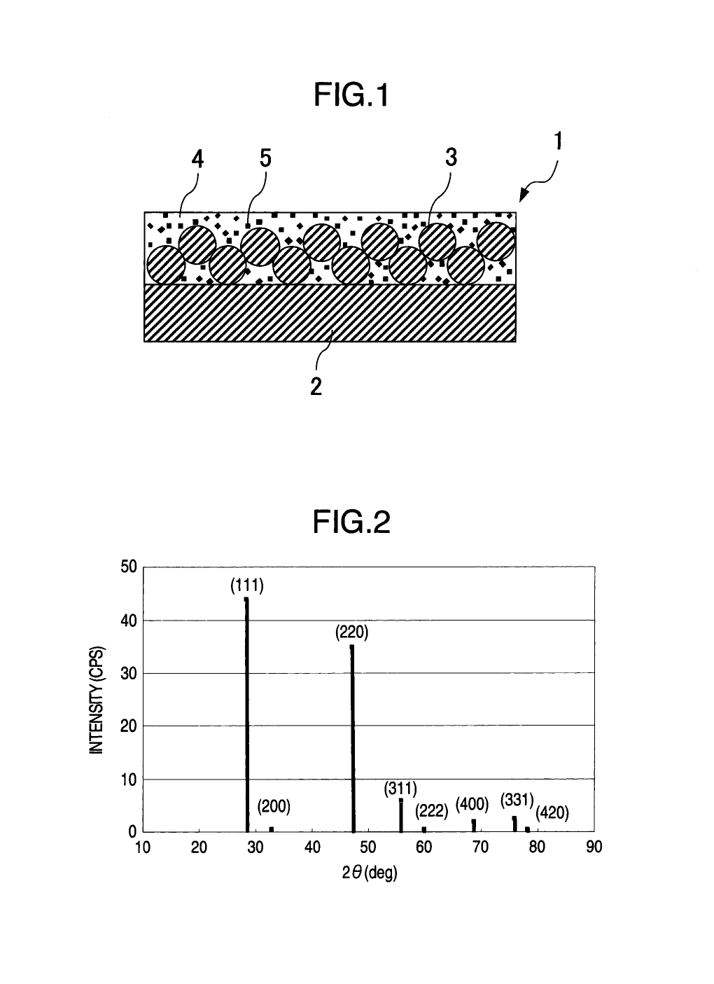

A resin sliding member 1 according to the present embodiment, in which calcium fluoride 5 is dispersed in a polyether ether ketone (hereinafter referred to as “PEEK”) resin 4, was manufactured by the processes described below. Firstly, in Examples 1 to 3 and 13, the PEEK resin 4 (“450G (trade name)” manufactured by Victrex plc) and the calcium fluoride 5 were stirred and mixed, in Examples 4 to 6, the PEEK resin 4, the calcium fluoride 5 and a predetermined solid lubricant were stirred and mixed, and in Examples 7 to 12, the PEEK resin 4, the calcium fluoride 5, the solid lubricant and a predetermined inorganic filler were stirred and mixed, where the mixtures had compositional ratios shown in Table 1. The obtained resin was each extruded while being melted and kneaded in an atmosphere of 380° C. to manufacture pellets having the compositional ratio shown in Table 1. Next, a sheet was manufactured from the obtained pellets by using a sheet extruder, and then, a surface of a metal base material which had been heated to 350° C. in advance was covered with the obtained sheet while being pressurized. A material composed of a steel back metal layer 2 and a porous metal layer 3, which was prepared in advance, was used as the metal base material, and the side of the porous metal layer 3 was impregnated and covered with a resin composition. Then, by forming the metal base material into a cylindrical shape such that the resin composition is located on the inner diameter side, the resin sliding member 1 in which the calcium fluoride 5 is dispersed in the PEEK resin 4 was manufactured as shown in FIG. 1. Regarding Examples 1 to 13 and Comparative Examples 1 and 2, a component composition of the resin composition, a peak intensity ratio between a (111) plane and a (220) plane of the calcium fluoride 5, and a friction coefficient and a backside temperature after 100 hours from the start of a sliding test are shown in Table 1. The backside temperature means a temperature of the cylindrically-shaped resin sliding member 1 on the side of the steel back metal layer 2, which is measured by a thermocouple.

TABLE 1

| | | | Example 1 | Example 2 | Example 3 | Example 4 | Example 5 | Example 6 | Example 7 | Example 8 |
|---|---|---|---|---|---|---|---|---|---|---|
| component | PEEK | | 99.5 | 90 | 75 | 85 | 85 | 85 | 80 | 80 |
| composition | calcium fluoride | | 0.5 | 10 | 25 | 10 | 10 | 10 | 10 | 10 |
| (vol %) | solid lubricant | fluorine resin | | | | 5 | | | 5 | 5 |
| | | graphite | | | | | 5 | | | |
| | | molybdenum disulfide | | | | | | 5 | | |
| | inorganic filler | barium sulfate | | | | | | | 5 | |
| | | phosphate compound | | | | | | | | 5 |
| | | potassium titanate | | | | | | | | |
| | | alumina | | | | | | | | |
| | | Iron oxide | | | | | | | | |
| | | carbon fiber | | | | | | | | |

| | | | | | | | | |
|---|---|---|---|---|---|---|---|---|
| peak intensity ratio between (111) plane and (220) | 1.3:1 | 1.3:1 | 1.3:1 | 1.3:1 | 1.3:1 | 1.3:1 | 1.3:1 | 1.3:1 |
| plane of calcium fluoride | | | | | | | | |
| friction coefficient after 100 hours | 0.25 | 0.30 | 0.36 | 0.25 | 0.27 | 0.27 | 0.29 | 0.29 |
| backside temperature after 100 hours | 68 | 72 | 74 | 68 | 69 | 70 | 70 | 71 |

| | | | Example | Example | Example | Example | Comparative | Comparative |
|---|---|---|---|---|---|---|---|---|
| | | Example 9 | 10 | 11 | 12 | 13 | Example 1 | Example 2 |
| component | PEEK | 80 | 80 | 80 | 80 | 90 | 90 | 90 |
| composition | calcium fluoride | 10 | 10 | 10 | 10 | 10 | 10 | 10 |

| | | | | | | |
|---|---|---|---|---|---|---|
| (vol %) | solid lubricant | fluorine resin | 5 | 5 | 5 | 5 |
| | | graphite | | | | |
| | | molybdenum disulfide | | | | |
| | inorganic filler | barium sulfate | | | | |
| | | phosphate compound | | | | |
| | | potassium titanate | 5 | | | |
| | | alumina | | 5 | | |
| | | Iron oxide | | | 5 | |
| | | carbon fiber | | | | 5 |

| | | | | | | | |
|---|---|---|---|---|---|---|---|
| peak intensity ratio between (111) plane and (220) | 1.3:1 | 1.3:1 | 1.3:1 | 1.3:1 | 1.1:1 | without | 0.9:1 |
| plane of calcium fluoride | | | | | | crystalline | |
| | | | | | | structure | |
| friction coefficient after 100 hours | 0.28 | 0.30 | 0.31 | 0.32 | 0.35 | 0.50 | 0.52 |
| backside temperature after 100 hours | 72 | 73 | 73 | 73 | 74 | 154 | 160 |

In Examples 1 to 12, as for the calcium fluoride 5, calcium fluoride was used which was pulverized by sequentially repeating; a step for rapidly rotating a cylindrically-shaped case storing natural calcium fluoride powders in a dry state therein in the circumferential direction and pressing the powders against the inner wall surface by centrifugal force to form a powder layer; a step for pressing the powder layer against the inner wall surface in such a way as to rub the powder layer on the inner wall surface with a slider to apply compression force; and a step for scraping the powder layer from the inner wall surface and shearing the scraped powder layer, and which calcium fluoride was made to have a crystalline orientation such that the peak intensity ratio between the (111) plane and the (220) plane of the calcium fluoride 5 was 1.3:1 when measured by an XRD method. The measurement result of the XRD method of the calcium fluoride 5 is shown in FIG. 2. In addition, even after manufacturing the resin sliding member 1 in which the calcium fluoride 5 was dispersed in the PEEK resin 4, the peak intensity ratio between the (111) plane and the (220) plane of the calcium fluoride 5 was 1.3:1 when the calcium fluoride 5 exposed on a sliding surface was measured by the XRD method. In the present embodiment, the calcium fluoride 5 manufactured by the above steps was pulverized by using “Ongmill (trade name)” manufactured by Hosokawa Micron Corporation. In Example 1, the calcium fluoride 5 having the average particle diameter of 1 μm was mixed into the PEEK resin 4. In Example 3, the calcium fluoride 5 having the average particle diameter of 20 μm was mixed into the PEEK resin 4. In Examples 2 and 4 to 12, the calcium fluoride 5 having the average particle diameter of 6 μm was mixed into the PEEK resin 4.

In Example 13, the calcium fluoride 5 was used which was manufactured by the similar method to that of Examples 1 to 12, but the pressure for pressing the powder layer against the case inner wall surface was decreased to about 70% of that in manufacturing of Examples 1 to 3. As a result, the calcium fluoride 5 in Example 13 was made to have a crystalline orientation such that the peak intensity ratio between the (111) plane and the (220) plane of the calcium fluoride 5 was 1.1:1 when measured by the XRD method. Even after manufacturing the resin sliding member 1 in which the calcium fluoride 5 was dispersed in the PEEK resin 4, the peak intensity ratio between the (111) plane and the (220) plane of the calcium fluoride 5 was 1.1:1 when the calcium fluoride 5 exposed on the sliding surface was measured by the XRD method. In addition, in Example 13, the calcium fluoride 5 having the average particle diameter of 6 μm was mixed into the PEEK resin 4 at a compositional ratio of 10 vol %.

In contrast, in Comparative Example 1, calcium fluoride was used which was obtained by adding a calcium chloride solution to a saturated sodium fluoride solution to prepare calcium fluoride by a precipitation method, separating a precipitate, washing and removing sodium and chlorine by centrifugation and filtration, and drying and pulverizing. Similar to the calcium fluoride described in JP-A-61-118452, the calcium fluoride obtained by the method is amorphous and does not have a crystalline structure. In Comparative Example 1, the calcium fluoride was mixed into the PEEK resin 4 at a compositional ratio of 10 vol %.

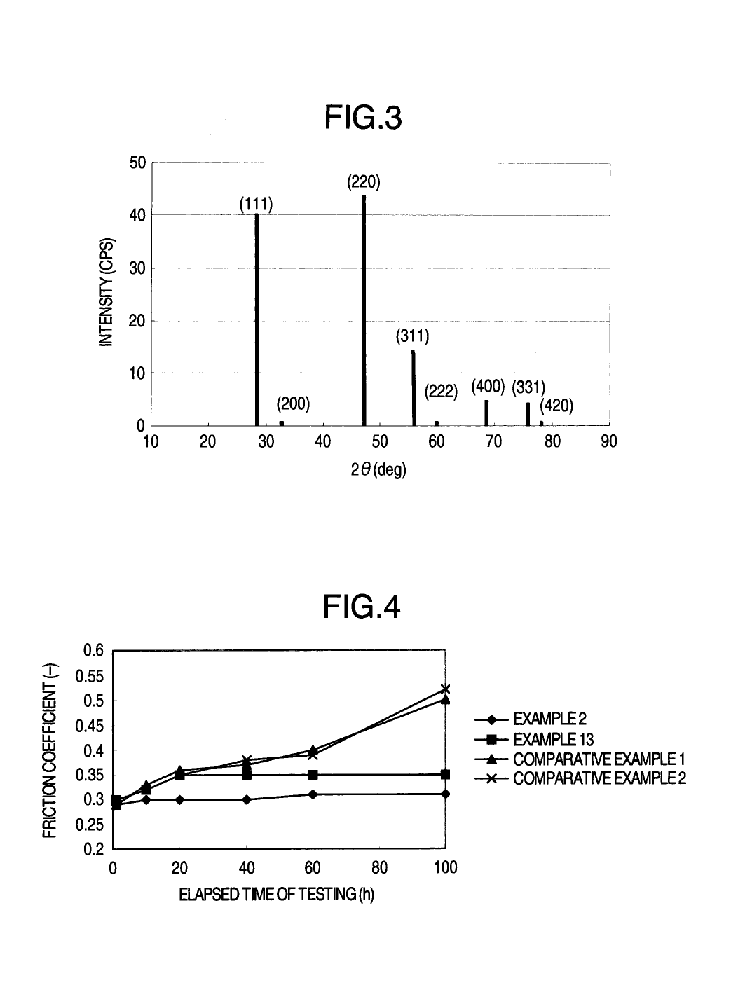

Moreover, in Comparative Example 2, the calcium fluoride was used which was obtained by pulverizing natural calcium fluoride with a ball mill, and in which the peak intensity ratio between the (111) plane and the (220) plane of the calcium fluoride was 0.9:1 when measured by the XRD method. The measurement result of the XRD method of the calcium fluoride is shown in FIG. 3. In addition, even after manufacturing the resin sliding member in which the calcium fluoride was dispersed in the PEEK resin, the peak intensity ratio between the (111) plane and the (220) plane of the calcium fluoride was 0.9:1 when the calcium fluoride was measured at the sliding surface by the XRD method. In Comparative Example 2, the calcium fluoride having the average particle diameter of 6 μm was mixed into the PEEK resin 4 at a compositional ratio of 10 vol %.

In the manufacturing method of the calcium fluoride powder in Examples 1 to 13, following steps are sequentially repeated: the step for pressing the powders against the inner wall surface by centrifugal force to form the powder layer, the step for pressing the powder layer against the inner wall surface in such a way as to rub the powder layer on the inner wall surface with the slider to apply compression force; and the step for scraping the powder layer from the inner wall surface and shearing the scraped powder layer. Among these steps, in the step for pressing the powder layer against the inner wall surface in such a way as to rub the powder layer on the inner wall surface with the slider to apply compression force, the calcium fluoride is likely to cause cleavage on (111) cleavage planes due to the compression force, and many cleavage planes are newly exposed. The newly-exposed cleavage plane is likely to be bonded to another newly-exposed cleavage plane because of its active state. However, in the step for scraping the powder layer from the inner wall surface and shearing the scraped powder layer, the powder layer is scraped while maintaining the newly-exposed (111) cleavage planes. Thus, the cleavage planes do not have much contact with each other, and recombination between the cleavage planes is reduced. Accordingly, it is thought that many (111) cleavage planes exist on particle surfaces of the calcium fluoride. In contrast, in Comparative Example 2, a general ball mill was used in which a hard ball made of a ceramic material or the like and a material to be pulverized were put into a container and the material was pulverized. In the case where natural calcium fluoride is pulverized with the ball mill, even if the (111) cleavage planes are newly exposed, the cleavage planes often come into contact with each other when using the ball mill, and the cleavage planes are likely to be recombined with each other. Therefore, it is thought that the crystal orientation of the particles obtained by pulverizing the natural calcium fluoride with the ball mill is not changed from that of the calcium fluoride before the pulverization.

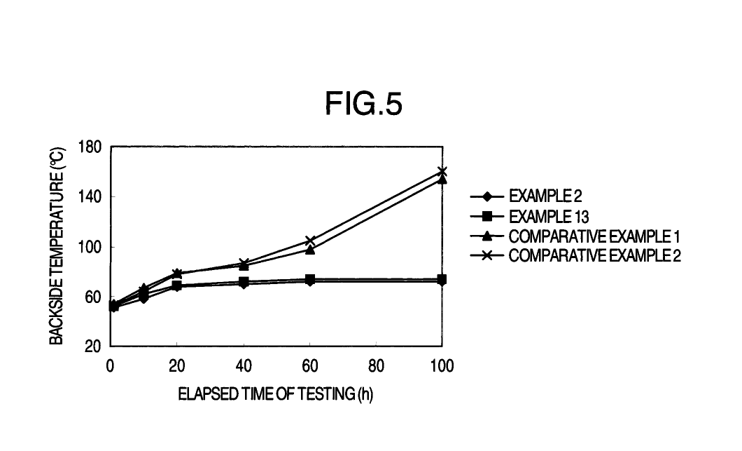

Next, with respect to Examples 1 to 13 using the resin sliding member 1 according to the present embodiment and Comparative Examples 1 and 2, the sliding test was performed with a sliding testing machine in an unlubricated condition. The sliding test was performed under testing conditions shown in Table 2 after press fitting the manufactured resin sliding member 1 into a housing, and friction coefficients were measured. As for the test results of Examples 1 to 13 and Comparative Examples 1 and 2, friction coefficients after 100 hours from the start of the test are shown in Table 1. Moreover, among Examples 1 to 13 and Comparative Examples 1 and 2, as for the test results of Examples 2 and 13 and Comparative Examples 1 and 2, in which the calcium fluoride 5 having the average particle diameter of 6 μm was mixed into the PEEK resin 4 at a compositional ratio of 10 vol %, changes in the friction coefficients and changes in the backside temperatures from the start to 100 hours of the test are shown in FIG. 4 and FIG. 5, respectively.

TABLE 2

| item | condition |
|---|---|
| contact pressure | 9.8 MPa |
| circumferential speed | 6 m/min |
| shaft material | SUJ2 hardening |
| testing shaft roughness | Ra 0.3 μm or less |

As shown in Table 1, in Examples 1 to 13, the friction coefficients after 100 hours from the start of the test are stably low within the range of 0.25 to 0.36. In contrast, in Comparative Examples 1 and 2, the friction coefficients after 100 hours from the start of the test are high within the range of 0.50 to 0.52. That is, by making the peak intensity of the (111) plane of the calcium fluoride 5 exposed on the sliding surface be larger than that of the (220) plane, the friction coefficient during steady wear can be kept low.

In addition, as shown in FIG. 4, in Examples 2 and 13 and Comparative Examples 1 and 2, the friction coefficients in any example from the start to 10 hours of the test is stably low within the range of 0.29 to 0.33. However, in Comparative Examples 1 and 2, when more than 20 hours have passed and initial wear is finished, the friction coefficients are increased. Furthermore, the friction coefficients are increased again between about 60 hours and 100 hours, and finally, the friction coefficients become about 0.52. It is thought that this is because, considering that the backside temperatures are rapidly increased after reaching 100° C. around 60 hours as shown in FIG. 5, the actual sliding surface exceeds 143° C., which is the glass-transition temperature of the PEEK resin, and original excellent sliding properties of the PEEK resin cannot be offered. In contrast, in Examples 2 and 13, the friction coefficients from the start to 100 hours of the test are stably low within the range of 0.30 to 0.35. That is, by making the peak intensity of the (111) plane of the calcium fluoride 5 exposed on the sliding surface be larger than that of the (220) plane, a friction coefficient increase during not only initial wear but also steady wear can be suppressed. Moreover, in Examples 2 and 13, since the backside temperatures after 100 hours are about 74° C. and the actual sliding surface does not exceed the glass-transition temperature of the PEEK resin, the original excellent sliding properties of the PEEK resin can be offered.

In the present embodiment, the porous part and the surface of the porous metal layer 3 formed on the steel back metal layer 2 was impregnated and covered with the composition of the resin sliding member 1. However, a base material such as a steel back metal layer may be covered with the composition of the resin sliding member 1 without forming a porous metal layer on the steel back metal layer. Moreover, the resin sliding member 1 of the present invention may be used without covering a base material.

1. A resin sliding member, comprising:
0.5 to 25 vol % of calcium fluoride dispersed as particles; and
a polyether ether ketone resin as a remainder,
wherein the calcium fluoride is crystalline, and
a peak intensity of a (111) plane of the calcium fluoride exposed on a sliding surface is larger than a peak intensity of a (220) plane.

2. The resin sliding member according to claim 1, further comprising 0.5 to 20 vol % of a solid lubricant.

3. The resin sliding member according to claim 2, wherein the solid lubricant is one or more selected from a fluorine resin, graphite and molybdenum disulfide.

4. The resin sliding member according to claim 1, further comprising 0.5 to 20 vol % of an inorganic filler.

5. The resin sliding member according to claim 4, wherein the inorganic filler is one or more selected from barium sulfate, a phosphate compound, potassium titanate, alumina, iron oxide and carbon fiber.

6. The resin sliding member according to claim 1, wherein an average particle diameter of the calcium fluoride is 1 to 20 μm.
